(19) United States
(12) Patent Application Publication
(10) Pub. No.: US 2012/0319959 A1
(43) Pub. Date: Dec. 20, 2012

(54) DEVICE INTERACTION THROUGH BARRIER

(75) Inventors: T. Scott Saponas, Woodinville, WA (US); Christopher Harrison, Pittsburgh, PA (US); Hrvoje Benko, Seattle, WA (US)

(73) Assignee: MICROSOFT CORPORATION, Redmond, WA (US)

(21) Appl. No.: 13/159,441

(22) Filed: Jun. 14, 2011

(51) Int. Cl. G06F 3/041

(52) U.S. Cl. 345/173

(57) ABSTRACT

There is provided an electronic device having a touch-sensing element configured for sensing touches on a surface thereof. A baseline sensitivity setting determines a sensitivity of the touch-sensing element. The touch-sensing element is configured to register a touch that meets or exceeds the baseline sensitivity setting, and to ignore a touch that does not meet the baseline sensitivity setting. The device further includes a sensor that senses an operating condition of the device. A memory of the device includes code executable by the device and configured to adjust the baseline sensitivity setting based upon the sensed operating condition.

### BACKGROUND

Modern mobile electronic devices, such as cellular phones, smart phones, laptops, and the like are sophisticated computing platforms that allow users to, for example, make phone calls, listen to music, surf the Web, send and receive emails and text messages, and perform various other tasks. These devices are often stored in pockets, bags, backpacks, their own carrying cases, purses, or other similar carrying locations. Thus, in order to interact with the device a user typically removes the device from its carrying location in order to access even the basic functionality of the device. Removing such devices from their carrying locations may be inconvenient or even difficult under certain conditions, such as when the user of the device is jogging, moving through an airport with luggage, or eating. Further, removing the device from its carrying location and interacting with the device may under certain circumstances be considered impolite or even rude.

Moreover, interfacing with a typical mobile electronic device to perform even relatively simple tasks, such as sending a text or email message or ignoring an incoming call, not only requires removal of the device from its carrying location but also may require a fair amount of cognitive and manipulative effort. For example, to ignore an incoming call on a typical device, a user may be obliged to remove the device from its carrying location, unlock or wake the device, look at the screen, select the “ignore” option, and return the device to its carrying location. Similarly, in order to send a brief text message in reply to a received text message a user may be obliged to remove the device from its carrying location, unlock or wake the device, look at the screen, select or navigate a menu to the “reply” option, enter the reply text, select or navigate a menu to the “send” command, and then return the device to its carrying case. These and many other actions require the user to visually examine and physically manipulate the device to a non-trivial degree.

### SUMMARY

The following is a brief summary of subject matter that is described in greater detail herein. This summary is not intended to be limiting as to the scope of the claims. It is intended to neither identify key elements of the claimed subject matter nor delineate the scope of the subject innovation. Its sole purpose is to present some concepts of the claimed subject matter in a simplified form as a prelude to the more detailed description that is presented later.

The claimed subject matter generally provides an electronic device having a touch-sensing element configured for sensing touches on a surface thereof. A baseline sensitivity setting determines a sensitivity of the touch-sensing element. The touch-sensing element is configured to register a touch that meets or exceeds the baseline sensitivity setting, and to ignore a touch that does not meet the baseline sensitivity setting. The device further includes a sensor that senses an operating condition of the device. A memory of the device includes code executable by the device and configured to adjust the baseline sensitivity setting based upon the sensed operating condition.

Another embodiment of the claimed subject matter relates to a method of interacting with an electronic device. The method includes determining a use position of the electronic device, and adjusting the sensitivity level of a touch-sensitive surface of the device dependent at least in part upon the determined use position. The method further includes detecting touches and strokes that occur on the touch-sensitive surface and which meet or exceed the sensitivity level. The method further includes excluding invalid detected touches and strokes. The method groups together the valid sequential touches and strokes, and interprets the grouped valid sequential touches and strokes as an alphanumeric string.

Yet another embodiment of the claimed subject matter relates to a non-transitory computer-readable storage medium that includes modules of instructions that, when executed by a processor of an electronic device, cause the electronic device to determine an operating condition, and to adjust a sensitivity level of a touch-sensing element of the device dependent upon the sensed operating condition. The instructions further cause the device to detect touches upon the touch-sensing element that meet or exceed the sensitivity level, and to exclude invalid detected touches. The instructions still further cause the device to group together the valid sequential touches, and to recognize the grouped valid sequential touches as a word or alphanumeric string.

### BRIEF DESCRIPTION OF THE DRAWINGS

FIG. 1 is a functional block diagram of an electronic device that includes one embodiment of a system for device interaction according to the subject innovation;

FIG. 2 is a functional block diagram of an electronic device that includes another embodiment of a system for device interaction according to the subject innovation;

FIGS. 3A-3D are diagrams that show the exemplary processing of certain sequential strokes according to one embodiment of the subject innovation; and

FIG. 4 is a process flow diagram that shows one embodiment of a method for interacting with an electronic device according to the subject innovation.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

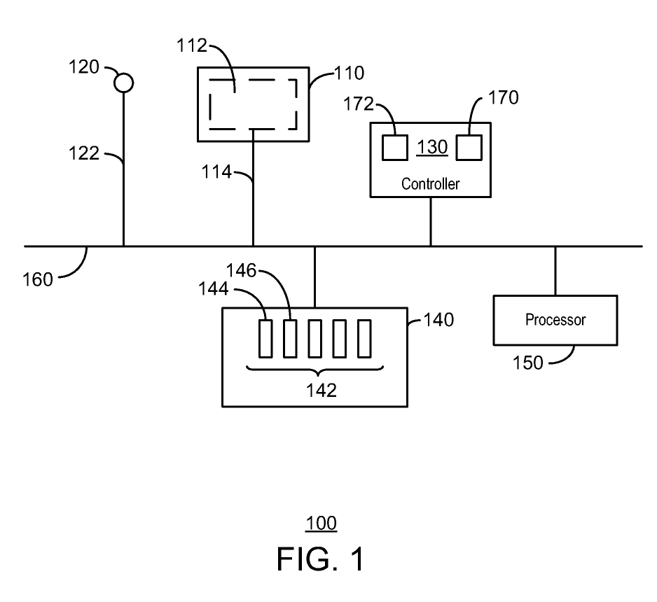

With reference now to FIG. 1, a block diagram an electronic device 100 having one embodiment of a system for device interaction according to the subject innovation is illustrated. The electronic device 100 includes a display screen 110, a sensor 120, a controller 130, a memory 140, processor 150 and a signal bus 160.

The electronic device 100 may be configured as virtually any type of electronic device, such as a smart phone or other mobile phone, a laptop computer, a tablet computer, an mp3 player, a gaming system, a voice or video recorder, a camera, an e-reader or e-book reader, or other electronic device that may sometimes be stored or placed in a carrying case, pocket, backpack, purse or other similar carrying or storage location.

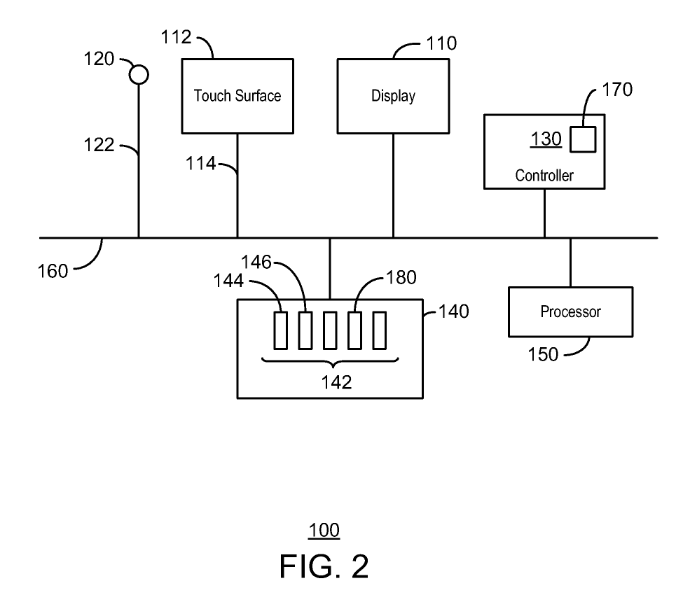

The display screen 110 may, in one embodiment, be a touch-sensitive screen having an integral touch element 112 that overlies or is otherwise associated with a surface of the display screen 110. The touch element 112 issues a touch signal 114 indicative of the occurrence of a touch event on the touch element 112. In one embodiment, the display screen 110 may be configured as a capacitive-sensing touch screen that includes an integral touch element 112. However, it is to be understood that the display screen 110 may be alternately configured as, for example, as a display screen having an integral touch element 112 configured as a resistive-sensing surface, a surface acoustic wave sensing surface, an infrared sensing surface, an acoustic pulse sensing surface or other suitable type of touch-sensitive surface. In another embodiment, as shown in FIG. 2, the touch element 112 may be separate from and non-integral with display screen 110 and can be, for example, disposed on one or more of the surfaces, such as a back, side or top surface, of the electronic device 100, and be configured as any of the foregoing sensing surfaces. In yet another embodiment, the touch element 112 may be disposed over or be integral with a substantial portion or the entire case or body of electronic device 100.

The sensor 120 may include one or more sensors configured to detect when a barrier such as one or more layers of fabric or other material may be in close proximity to or overlying the touch element 112. As such, the sensor 120 is configured to detect when the electronic device 100 may have been placed in its carrying case or other carrying location. In one embodiment, the sensor 120 may be configured to sense, for example, an ambient light level, proximity, or other appropriate parameter or combination of parameters indicative of one or more layers of fabric or other material being disposed in close proximity to or overlying the touch element 112. In another embodiment, the sensor 120 may be configured to sense the self-capacitance of one or more areas or portions of the touch element 112 to thereby detect whether one or more layers of fabric or other material is in close proximity to the touch element 112. The sensor 120 may issue a sense signal 122 indicative of whether one or more layers of fabric or other material may be in close proximity to or overlying the touch element 112.

For the sake of clarity, the terms carrying location, carrying case and storage location, as used herein, shall mean a pocket, bag, backpack, carrying case, purse, or other similar location in which the electronic device 100 may be placed and by which placement one or more layers of fabric or other material may be in close proximity to or overlying the touch element 112.

The controller 130 may be configured as a touch screen or touch surface controller that can detect and register the location of a touch occurring on the touch element 112. In the embodiment shown, the touch element 112 may be configured as a capacitive touch screen, and the controller 130 may correspondingly be configured to detect and register the location of a conductive element touching the touch element 112 based at least in part upon a change in the measured capacitance of the touch element 112 as indicated, at least in part, by the touch signal 114 which is received by or otherwise provided to the controller 130.

The memory 140 may include one or more non-transitory computer-readable storage media, such as random access memory, read only memory, or any combination of the foregoing in any suitable configuration, including removable and non-removable, volatile and non-volatile, flash, disk drive, or any other type and configuration of memory suitable for use in electronic device 100. The memory 140 may include various instruction modules 142, including an operating system 144, firmware 146, and a recognition module 148, as well as other modules 142 that enable the operation and various functions of electronic device 100. The modules 142 are computer- or processor-executable sets of instructions that, when executed by the processor 150, cause the electronic device 100 to perform certain corresponding functions.

The processor 150 may be configured as a microprocessor that executes the modules 142 to facilitate the subject innovation, as will be more particularly described, as well as executing other modules 142 to control and/or enable the operation of the electronic device 100.

Each of the display screen 110, the sensor 120, the controller 130, the memory 140 and the processor 150 can be communicatively coupled to the bus 160 over which electronic signals and data, including the touch signal 114 and the sense signal 122, are exchanged. The bus 160 may be configured as a universal serial bus (USB) or other type of bus suitable for use in the electronic device 100.

The firmware module 146 can be executed by the processor 150 to apply baseline sensitivity settings 170 that determine the sensitivity level of the touch element 112, dependent at least in part upon the sense signal 122. More particularly, the processor 150 executes firmware module 146 to continuously, periodically, or on demand, adjust the baseline sensitivity settings 170 to thereby adjust the sensitivity level of the touch element 112, dependent at least in part upon the sense signal 122. The baseline sensitivity settings 170 determine, at least in part, which touches will and which touches will not be detected by touch element 112.

For the sake of clarity, it is noted that the term valid touch as used herein shall mean a direct or indirect touch that is detected and meets, whereas an invalid touch is defined as a touch that is detected but does not meet, the characteristics of a valid touch, as will be more particularly described hereinafter. The terms contact, contacts, touch, touches, as used herein shall, unless otherwise indicated, encompass various types of valid and invalid contacts upon the touch element 112. Various types of touches may occur, including a tap (which is defined as a single touch lasting less than or equal to a predetermined time), a press (which is defined as a touch that persists for at least a predetermined minimum amount of time), a stroke or moving contact/touch (a touch that in a substantially uninterrupted manner traverses at least a predetermined minimum portion of the touch element 112) and the like.

When the sense 122 signal indicates that the electronic device 100 is disposed in a normal-use position, such as, for example, on a table or being held by a user, the processor 150 executing the firmware module 146 causes the controller 130 to set or adjust the baseline sensitivity settings 170 to a corresponding and appropriate level for the currently-sensed operating condition, i.e., the normal-use operating condition. The baseline sensitivity settings 170 for such a normal-use operating condition may be referred to as the default or normal-use baseline sensitivity level, and are well-suited for the controller 130 to detect and register direct touches or contacts by a user on the touch element 112, all of which touches are represented by the touch signal 114, and to reject or ignore touches that are weaker than or fall below the normal-use sensitivity settings.

Similarly, when the sense signal 122 indicates that the electronic device 100 is in a storage or carrying location, such as in a pocket, and thus that one or more layers of fabric or other material are in close proximity to or overlying the touch element 112, the processor 150 executing the firmware module 146 causes controller 130 to adjust the baseline sensitivity settings 170 to a corresponding and appropriate level for the currently-sensed operating condition, i.e., the storage or carrying-location operating condition. The baseline sensitivity settings 170 for such a carrying-location operating condition may be referred to as the carrying-location sensitivity level, and are well-suited for the controller 130 to detect and register indirect touches on the touch element 112, all of which touches are represented by the touch signal 114, and reject or ignore touches that are weaker than or fall below the carrying-location baseline sensitivity level.

Any indirect touch upon touch element 112, such as a touch that occurs through one or more layers of fabric or material, will be attenuated to a degree that depends at least in part upon the characteristics of the fabric or material disposed between a touching member, such as a finger, and the touch element 112. Accordingly, in one embodiment hereof, adjusting the baseline sensitivity settings 170 may include increasing the sensitivity level of the touch element 112 relative to the normal-use baseline sensitivity settings when the carrying-location baseline sensitivity level is applied. In such an embodiment, the touch element 112 may be less sensitive when the baseline sensitivity level is applied than when the carrying-location baseline sensitivity level is applied. Thus, when the carrying-location baseline sensitivity is applied the controller 130 will detect and register relatively light or soft direct and indirect touches on the touch element 112, all of which touches are represented by the touch signal 114, and will reject or ignore touches that are weaker than or fall below the carrying-location baseline sensitivity level.

However, in the embodiment wherein the baseline sensitivity settings 170 are adjusted to the carrying-location baseline sensitivity level, and thus to a more sensitive level relative to the normal-use baseline sensitivity level, and with the electronic device 100 stored in a storage location where one or more layers of fabric or other material are disposed in close proximity to or overlaid upon the touch element 112, there is increased likelihood for false or invalid touches to occur. These false or invalid touches will be detected and registered by the touch element 112, and may be included within or otherwise reflected by the touch signal 114. These false or invalid touches may also be referred to as noise. For example, when the electronic device 100 is in a pocket and the fabric of the pocket or another object in the pocket comes into contact with the touch element 112 invalid touches or noise may be generated, and such noise may be included in the touch signal 114 received or otherwise provided to controller 130.

The controller 130, in one embodiment, is configured to distinguish between such noise and valid touches. In such an embodiment, the processor 150 may execute the firmware module 146 to cause the controller 130 to filter, exclude, or otherwise remove invalid touches or noise that may be included in or represented by the touch signal 114. The filtering may be based on one or more attributes or parameters of the touch as reflected by the touch signal 114.

In another embodiment, the processor 150 executing the firmware module 146 can cause the controller 130 to ignore or reject any touches that have a duration that is less than a predetermined minimum amount of time, to ignore or reject touches that do not traverse a predetermined minimum portion of the touch element 112, to ignore or reject touches that do not traverse a predetermined target portion of or location upon the touch element 112, to ignore or reject touches that occur across more than a predetermined portion of the touch element 112 (e.g., the object touching the touch element 112 is detected as exceeding an anticipated size of a touching member), or to apply other criteria and parameters to distinguish between valid and invalid touches or noise. In this embodiment, a second sensor, such as an accelerometer or other sensor, may be used to distinguish between valid and invalid touches. More particularly, the processor 150 executing the firmware 146 may, in addition to touch 114 signal, also consider signals or other indications from other sensors of the electronic device 100 in order to distinguish between valid and invalid touches.

In yet another embodiment, the processor 150 executing the firmware 146, rather than the controller, performs the filtering of the noise or otherwise invalid signals that may be present in the touch signal 114. In yet another embodiment, the controller 130 may be configured as or include a processor and may itself execute the firmware 146 to thereby filter the noise or otherwise invalid signals that may be present in touch 114 signal. In a still further embodiment, the firmware 146 module can be included within a memory of the controller 130.

The filtering of noise and otherwise invalid signals occurring upon the touch element 112 and that may be present in touch signal 114 is also facilitated at least in part through adjustment of the baseline sensitivity settings 170 of the touch element 112. As described above, the processor 150 executing the firmware module 146 causes the controller 130 to adjust the baseline sensitivity settings 170 to a corresponding and appropriate level for the current operating condition as indicated at least in part by sensor 120 and sense signal 122. In one embodiment, the baseline sensitivity settings 170 of the touch element 112 are periodically adjusted. More particularly, the firmware 146 module when executed by the processor 150 may be configured to periodically read sense 122 signal and, based at least in part thereon, adjust the baseline sensitivity settings 170 of the touch element 112. In this embodiment, the baseline sensitivity settings 170 of the touch element 112 may be adjusted in a substantially-continuous or other periodic manner, for example every 100 milliseconds or over any other suitable time period. It should be further noted that, in this embodiment, the baseline sensitivity settings 170 are not necessarily limited to discrete values or levels of sensitivity for a detected operating condition, but rather are also substantially-continuously variable in terms of the value or level of sensitivity.

The touches that are not ignored, rejected or otherwise filtered by the execution of firmware 146 may be considered valid touches. In one embodiment, execution of the firmware module 146 may be configured to pre-process the valid touches to, for example, smooth or merge together strokes having irregularities such as gaps or discontinuities in an intended single unitary stroke, such as where the intended single stroke has a discontinuity wherein a first portion of the intended single stroke has an end that is temporally and spatially near a beginning portion of a second portion of the intended single stroke.

As noted above, various types of valid touches may occur upon touch element 112, such as a tap, stroke or press. The various types of valid touches or combinations thereof may be processed by electronic device 100 to, in one embodiment, invoke certain functions, to cause certain functions to be performed, or be interpreted as textual or character input. As noted above, the processor 150 executes the firmware module 146 to cause the controller 130 to filter, exclude, or otherwise remove invalid touches or noise that may be included in or represented by touch signal 114.

The processor 150 executing recognition module 148 processes the valid touches. The recognition module 148 as executed by processor 150 is configured, in one embodiment, to interpret the certain types of valid touches as corresponding to alphanumeric characters, gestures or commands. For example, in one embodiment, a tap anywhere on the touch element 112 may be recognized by the recognition module 148 or applied as a command to place the electronic device 100 in a silent or muted mode of operation, whereas a press anywhere on touch element 112 may be recognized by the recognition module 148 as a command to place the electronic device 100 in a designated mode of operation, such as a telephone mode.

In yet another embodiment, one or more predetermined strokes on touch element 112, such as a stroke in the shape of the capital letter “L” or two parallel strokes “∥”, may be recognized by recognition 148 module as a command or stroke by which the coordinate system for inputting subsequent touches or strokes via touch element 112 is established. The use of such predetermined strokes enables, at least in part, the electronic device 100 to determine, via recognition 148 module, an orientation of the electronic device 100 relative to the user, and thereby indicates, for example, the top, bottom and sides of the touch element 112 relative to the user. The same one or more predetermined strokes may also be recognized by recognition 148 module as corresponding to one or more additional commands, such as a command to unlock and/or wake the electronic device 100 from a stand-by or sleep mode and as a command to adjust the baseline sensitivity of the touch element 112, and thus the predetermined special strokes may serve two or more purposes making operation of and interface with the electronic device 100 more efficient.

Due to the small screen sizes found on many electronic devices, separate touches or strokes may occur within the same space or location on the touch element 112 and yet occur at different times or sequentially. Accordingly, the recognition module 148 may further be configured to distinguish between touches or strokes that occur in the same space of touch element 112, and thus overlap and/or overlie each other but are separated in time, to thereby form groups of sequential strokes. Groups of sequential strokes may be delineated by a predetermined touch or stroke, such as a stroke on the touch element 112 that corresponds to the “>” symbol (the “greater than” symbol), by a tap or double tap upon the touch element 112, or by a simple pause in stroke or touch entry. The recognition module 148 may be configured to group together sequential strokes that occur between or precede the delineating characters, and to configure those groups of sequential strokes as though they were written on a continuous line. The recognition module 148 is further configured to convert the groups of sequential strokes into words by, for example, applying a suitable text recognition method that incorporates a language model for word recognition, such as the Microsoft® Ink application programming interface or similar text and word recognition method.

The recognition module 148 is further configured to combine and interpret together certain sequential strokes rather than interpreting those strokes as separate strokes. Certain characters, such as small-case letters including “k”, “t” and “x”, are formed from separate and sequential strokes that are separated temporally yet indicate a single character or letter. The separate strokes used to form these certain characters or letters contain a set of predetermined second strokes, including strokes corresponding to the symbols “<”, “−”, “\” or “/” (i.e., the less than symbol, the dash symbol, the backward slash symbol, and the forward slash symbol, respectively). The recognition module 148 is configured to combine a member of the set of predetermined second strokes with the preceding stroke.

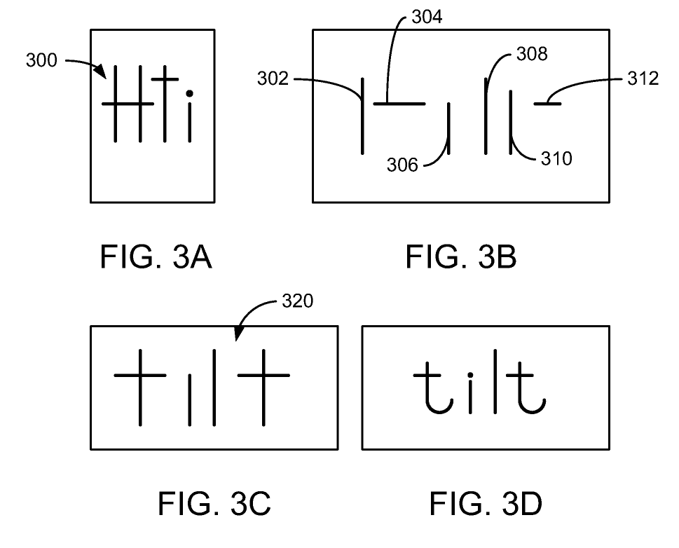

With reference now to FIGS. 3A-3D, the processing of certain sequential strokes on the touch element 112 is illustrated. An exemplary collection of strokes 300 that occurred upon and were detected by the touch element 112 are illustrated in FIG. 3A. Although the strokes 300 may be temporally separated, the strokes 300 nonetheless occur upon and traverse common or overlapping portions of the touch element 112. The recognition module 148 as executed by the processor 150 is configured to distinguish between touches or strokes that occur in the same space of the touch element 112 but are separated in time, and thereby form groups of sequential strokes. The strokes 300 as temporally separated into strokes 302, 304, 306, 308, 310 and 312 by the recognition module 148 are illustrated in FIG. 3B.

As discussed above, the recognition module 148 may be configured to combine together certain sequential strokes rather than treating those strokes as individual and separate strokes. As shown in FIG. 3C, the recognition module 148 as executed by the processor 150 combines together strokes 302 and 304, and combines together strokes 310 and 312, each of which were made at different times and thus each constitutes separate but sequential touches or stroke events on the touch element 112. The combined strokes form a text input 320 that is further processed by the recognition module 148 to interpret or convert the text input 320 into a word, such as by applying a suitable text recognition method that incorporates a language model for word recognition. As shown in FIG. 3D, the resulting word or group of alphanumeric characters 330 is produced.

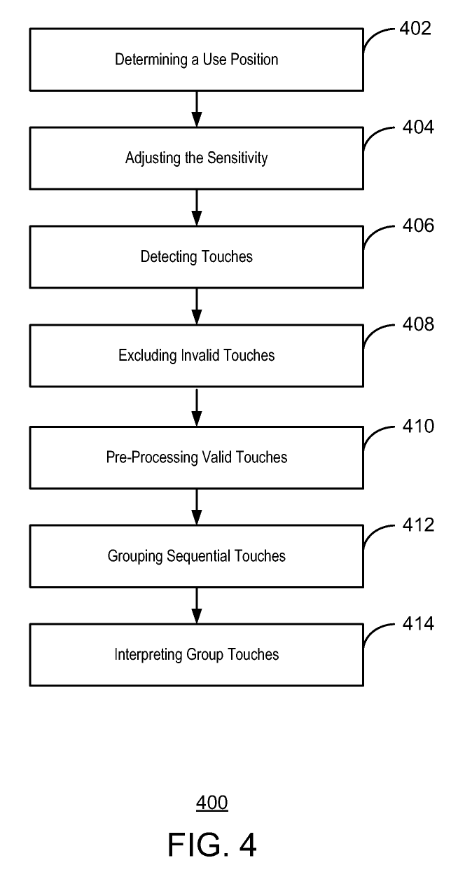

With reference now to FIG. 4, a method 400 of device interaction of the subject innovation is illustrated. The method 400 includes determining 402 a use position of a device, adjusting 404 the sensitivity of a touch-sensitive surface of the device, detecting 406 touches upon the touch-sensitive surface, and excluding 408 invalid detected touches, pre-processing 410 valid touches, grouping 412 sequential touches, and interpreting 414 grouped touches.

Determining 402 a use position of the device includes determining whether the device is in a normal-use operating condition or whether the device is in a carrying-location operating condition. In one embodiment, the determining 402 step may include sensing an ambient light level surrounding the device or the proximity of one or more layers of fabric or other material relative to the device or a touch-sensitive surface thereof.

Adjusting 404 the sensitivity of a touch-sensitive surface of the device includes applying to the touch-sensitive surface a baseline sensitivity setting that corresponds to the use position indicated by the determining 402 step. In one embodiment, adjusting 404 the sensitivity may include applying a normal-use baseline sensitivity setting to the touch-sensitive surface when the device is determined to be in the normal-use operating condition, and applying a carrying-location baseline sensitivity setting to the touch-sensitive surface when the device is determined to be in a carrying-location operating condition. In one embodiment, the carrying-location baseline sensitivity setting may be more sensitive than the normal-use baseline sensitivity setting.

Detecting 406 touches upon the touch-sensitive surface includes sensing the touches upon the touch sensitive surface. In one embodiment, the touches are detected by a capacitive-sensing method or surface by measuring or otherwise detecting a change in the capacitance of the touch-sensitive surface.

Excluding 408 invalid detected touches includes filtering out or otherwise rejecting touches based on one or more attributes or parameters of the touch or stroke. In one embodiment, touches that have a duration that is less than a predetermined minimum amount of time, that do not traverse a predetermined minimum portion of the touch-sensing surface, that do not traverse a predetermined target portion of or location upon the touch-sensitive surface, or that fail to satisfy other criteria or parameters may be rejected. The touches and strokes that are not excluded are processed by the method 400 as valid touches.

Pre-processing 410 valid touches includes augmenting the detected and valid touches and/or strokes to, for example, remove erroneous discontinuities, smooth edges, remove noise, and to eliminate other erroneous characteristics that may be included with or form part of the valid touches.

Grouping 412 sequential touches includes grouping together detected and valid sequential touches and strokes into a character or text string. In one embodiment, detected and valid strokes and/or touches that occur before, after or between predetermined delineating strokes or touches are sequentially grouped together into a character or text string. In another embodiment, grouping 412 sequential touches may further include combining into a single character a first stroke and a second stroke, wherein the second stroke is the next-occurring valid stroke relative to the first stroke. In that embodiment, strokes corresponding to a predetermined set of characters or symbols, such as the symbols “<”, “−”, “\” or “/”, are combined with the immediately preceding stroke to form representations of certain alphanumeric characters, such as representations of the small-case letters “k”, “t” and “x”.

Interpreting 414 grouped touches includes processing the character or text string resulting from grouping 412 to form a word or alphanumeric string. Interpreting 414 grouped touches may, in one embodiment, include processing the character or text string resulting from grouping 412 with a suitable text recognition method that incorporates a language model for word recognition to thereby identify the character or text string as a word or as an otherwise known alphanumeric string, such as an acronym, abbreviation, slang, command, or other known string. The word or alphanumeric string identified by the interpreting 414 process may then be accepted without further action, reviewed and accepted, or revised by a user of the electronic device. If accepted or confirmed, the word or alphanumeric string is configured to be readable by or otherwise in a format compatible with an input to the electronic device, and can without further processing be used, for example, as an input value or word for use in an application, or as a command, action, function, or other entry.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An electronic device, comprising:
a touch-sensing element configured for sensing touches on a surface thereof, the touch-sensing element having a baseline sensitivity setting that determines at least in part a sensitivity of the touch-sensing element, the touch-sensing element configured to register a touch that meets or exceeds the baseline sensitivity setting and configured to ignore a touch that does not meet the baseline sensitivity setting;
a sensor sensing an operating condition of the device, and indicating the sensed operating condition; and
a memory including code executable by the electronic device, to adjust the baseline sensitivity setting of the touch-sensing element based at least in part upon the sensed operating condition.

2. The electronic device of claim 1, wherein the sensor is configured to sense a parameter indicative of whether the electronic device is in a normal-use operating condition or a carrying-location operating condition.

3. The electronic device of claim 2, wherein the parameter sensed by the sensor is at least one of an ambient light level proximate the electronic device and a proximity of a material relative to the surface of the touch-sensing element.

4. The electronic device of claim 3, wherein the code applies a first baseline sensitivity level to the touch-sensing element when the electronic device is in the normal-use operating condition, and applies a second baseline sensitivity level to the touch-sensing element when the electronic device is in the carrying-location operating condition, the second baseline sensitivity setting increasing the sensitivity of the touch-sensing element relative to the first baseline sensitivity level.

5. The electronic device of claim 4, wherein the code as executed by the device is configured to determine whether a touch sensed by the touch-sensing element is a valid or invalid touch.

6. The electronic device of claim 1, wherein the memory further comprises a recognition module executable by the processor, and is configured to form a group of alphanumeric characters based at least in part upon touches that occur sequentially upon the surface of the touch-sensing element.

7. The electronic device of claim 6, wherein the recognition module is further configured to distinguish between sequential touches that one of occur upon and traverse a common portion of the surface of the touch-sensing element.

8. The electronic device of claim 7, wherein the recognition module is further configured to combine together as a single character a touch having at least one of a plurality of predefined characteristics with an immediately preceding touch.

9. The electronic device of claim 7, wherein the recognition module is further configured to form a text input dependent at least in part upon the group of alphanumeric characters, and to recognize the text input as one of a word and an identifiable string of alphanumeric characters.

10. The electronic device of claim 1, wherein the touch-sensing element is a capacitive-sensing element.

11. The electronic device of claim 10, wherein the surface of the touch-sensing element is integral with a display screen of the electronic device.

12. The electronic device of claim 10, wherein the surface of the touch-sensing element is one of disposed on or integral with a surface of the device.

13. The electronic device of claim 10, wherein the code as executed by the device is configured to periodically adjust the baseline sensitivity setting.

14. A method of interacting with an electronic device, comprising:
determining a use position of the electronic device;
adjusting a sensitivity level of a touch-sensitive surface of the device dependent at least in part upon the determined use position;
detecting touches and strokes occurring on the touch-sensitive surface and which meet or exceed the sensitivity level;
excluding invalid detected touches and strokes;
grouping together the valid sequential touches and strokes; and
interpreting the grouped valid sequential touches and strokes to thereby recognize the sequential touches and strokes as an alphanumeric string.

15. The method of claim 14, wherein adjusting the sensitivity level comprises adjusting the sensitivity level to a carrying-location sensitivity level when the determining indicates a carrying-location position, and adjusting the sensitivity level to a normal-use sensitivity level when the determining step indicates a normal-use position, wherein the carrying-location sensitivity level increases the sensitivity of the touch-sensitive surface relative to the normal-use sensitivity level.

16. The method of claim 14, wherein determining comprises sensing the presence of a material in close proximity to the touch-sensitive surface to thereby determine the use position is a carrying-location position, and further comprises sensing there is no material in close proximity to the touch-sensitive surface to thereby determine the use position is a normal-use position.

17. The method of claim 14, wherein adjusting the sensitivity level comprises adjusting the sensitivity level to a carrying-location sensitivity level when the determining indicates a carrying-location position, and adjusting the sensitivity level to a normal-use sensitivity level when the determining step indicates a normal-use position, wherein the carrying-location sensitivity level increases the sensitivity of the touch-sensitive surface relative to the normal-use sensitivity level.

18. The method of claim 14, wherein grouping together the valid sequential touches and strokes comprises distinguishing between separate touches and strokes that occur upon or traverse a common or overlapping area of the touch-sensitive surface, and further comprises combining together as a single character a touch or stroke having at least one of a plurality of predefined characteristics with an immediately-preceding touch or stroke.

19. The method of claim 14, wherein adjusting the sensitivity level further comprises periodically adjusting the sensitivity level.

20. One or more computer-readable storage media comprising code configured to direct a processing unit to:
sense an operating condition of the device;
adjust a sensitivity level of a touch-sensing element of the device dependent upon the sensed operating condition;
detect touches upon the touch-sensing element that meet or exceed the sensitivity level;
exclude invalid detected touches;
group together valid sequential touches; and
interpret the grouped valid sequential touches to recognize an alphanumeric string.
